(19) United States
(12) Patent Application Publication
(10) Pub. No.: US 2025/0390582 A1
(43) Pub. Date: Dec. 25, 2025

(54) SECURITY ALGORITHM SELECTION SYSTEM AND SELECTION METHOD THEREOF

(71) Applicant: Chelpis Quantum Corporation, Taipei (TW)

(72) Inventor: Chia-Yen LU, Taipei (TW)

(21) Appl. No.: 18/753,947

(22) Filed: Jun. 25, 2024

(51) Int. Cl. G06F 21/57

(52) U.S. Cl. CPC G06F 21/577; G06F 2221/034

(57) ABSTRACT

A security algorithm selection system and a selection method thereof, which has an environment scanning unit for scanning an electronic device and obtaining a runtime environment information, an algorithm evaluation unit equipped with at least one joint continuous density function, and a risk evaluation unit with at least one judgment module, the risk evaluation unit obtains a first security algorithm information from the algorithm evaluation unit, obtains an implementation security algorithm from a security algorithm instance database, obtains a corresponding risk datum from an instance risk database, then generates at least one second security algorithm information through calculation by the judgment module, and then transmits the second security algorithm information to the electronic device.

### BACKGROUND OF THE INVENTION

### Field of Invention

The invention relates to a security algorithm selection system and a selection method thereof, more particularly to a security algorithm selection system and a selection method thereof capable of quickly selecting suitable hardware and meeting requirements of users.

### Related Art

With the development of science and technology, the computing power of computers continues to improve, and related applications continue to develop. One of the most eye-catching fields is “quantum science”, and we are standing on the threshold of the “post-quantum era” currently; quantum computer, a brand-new computing tool, is bringing about drastic changes in the field of information security. Traditional encryption methods, such as RSA and elliptic curve encryption, will become vulnerable to the threat of quantum computer, so post-quantum cryptography has also developed.

The number of traditional encryption algorithms is small, so the problem of which algorithm should be used is less likely to arise. However, there is currently a wide variety of security algorithms produced using quantum cryptography, and most of their designs are based on doubling the key length to reduce the risk of data being decrypted. However, after doubling the length of the key, the amount of encryption and decryption operations also increases exponentially. Therefore, which implementation method of quantum cryptography should be selected and which one is suitable for use is an urgent problem to be solved.

Therefore, the inventor of the invention and relevant manufacturers engaged in this industry are eager to research and make improvement to solve the above-mentioned problems and drawbacks in the prior art.

### SUMMARY OF THE INVENTION

Therefore, in order to effectively solve the above problems, a main object of the invention is to provide a security algorithm selection system capable of quickly selecting suitable hardware and meeting requirements of users.

A secondary object of the invention is to provide a secure algorithm selection system capable of greatly improving an algorithm selection efficiency.

A secondary object of the invention is to provide a security algorithm selection method capable of quickly selecting suitable hardware and meeting requirements of users.

A secondary object of the invention is to provide a secure algorithm selection method capable of greatly improving an algorithm selection efficiency.

In order to achieve the above objects, the invention provides a security algorithm selection system comprising an electronic device, an environment scanning unit, a security algorithm database, an algorithm evaluation unit, a security algorithm instance database, an instance risk database and a risk evaluation unit, the electronic device comprises at least one runtime environment information, the environment scanning unit is used to scan the electronic device and obtain the runtime environment information, the security algorithm database comprises a security algorithm and a security algorithm information, the algorithm evaluation unit is equipped with at least one joint continuous density function, the algorithm evaluation unit receives the runtime environment information from the environment scanning unit, receives the security algorithm from the security algorithm database, and then uses the joint continuous density function to operate the runtime environment information and the security algorithm to generate a first security algorithm information, the security algorithm instance database comprises at least one implementation security algorithm and an implementation security algorithm information, the instance risk database comprises at least one corresponding risk datum, the corresponding risk data are corresponding risk data of various instances of the security algorithm and the implementation security algorithm, the risk evaluation unit has at least one judgment module, the risk evaluation unit obtains the first security algorithm information from the algorithm evaluation unit, obtains the at least one corresponding risk datum from the instance risk database, generates at least one second security algorithm information through calculation by the judgment module, and then transmits the second security algorithm information to the electronic device.

In one embodiment, further comprising an algorithm regrouping unit for obtaining the second security algorithm information from the risk evaluation unit, screening the second security algorithm information, and then regrouping the screened second security algorithm information to generate at least one instruction set, and transmitting the instruction set to the electronic device.

In one embodiment, the joint continuous density function can be either a probability model or an analytic function or a combination thereof corresponding to a latent space.

In one embodiment, the first security algorithm information and the second security algorithm information comprise one of an equation, execution steps, effectiveness consumption, effectiveness requirements, implicit risks, exception detection, exception handling, or a combination thereof, which can be transformed into at least one instruction set based on information contained therein.

In one embodiment, the joint continuous density function is generated by using a retrospective database with at least one learning algorithm, the retrospective database comprises either at least one set of multi-dimensional information or an expected output of the learning algorithm, or a combination thereof.

In one embodiment, one of the security algorithm database, the retrospective database, the instance risk database, the security algorithm instance database, or a combination thereof is updated automatically or manually based on a joint continuous density function trained by a learning algorithm.

In order to achieve the above objects, the invention provides a security algorithm selection method comprising following steps:
S1: using an environment scanning unit to scan an electronic device and obtaining a runtime environment information of at least one electronic device;
S2: inputting the runtime environment information, at least one security algorithm, and at least one security algorithm information into an algorithm evaluation unit, and generating at least one first security algorithm information through operation of the algorithm evaluation unit;
S3: inputting the first security algorithm information, at least one implementation security algorithm, at least one implementation security algorithm information and at least one corresponding risk datum into a risk evaluation unit, and generating at least one second security algorithm information through operation of the risk evaluation unit; and
S4: transmitting the second security algorithm information to the electronic device.

In one embodiment, after step S3 of generating at least one second security algorithm information through operation of the risk evaluation unit, further comprising:
S5: an algorithm regrouping unit regrouping the second security algorithm information to generate at least one instruction set;
S6: the algorithm regrouping unit transmitting the instruction set to the electronic device;
S7: using one of the runtime environment information, the security algorithm, the security algorithm information, the first security algorithm information, the implementation security algorithm, the implementation security algorithm information, the corresponding risk datum, the second security algorithm information, the instruction set or a combination thereof to generate a runtime log information and storing the runtime log information in a storage unit; and
S8: a comparison unit obtaining the runtime environment information, comparing the runtime log information with the runtime environment information, and then outputting the second security algorithm information or the instruction set to the electronic device.

### BRIEF DESCRIPTION OF THE DRAWINGS

FIG. 1 is a block diagram of a first embodiment of a security algorithm selection system of the invention;

FIG. 2 is a generation method of a joint continuous density function of the security algorithm selection system of the invention;

FIG. 3 is a schematic diagram of data contained in a retrospective database of the security algorithm selection system of the invention;

FIG. 4 is a schematic diagram of an action mode of the joint continuous density function of the security algorithm selection system of the invention;

FIG. 5 is a schematic diagram of a modulation method of the joint continuous density function of the security algorithm selection system of the invention;

FIG. 6 is a curve diagram of a modulation method of the joint continuous density function of the security algorithm selection system of the invention;

FIG. 7 is a block diagram of a second embodiment of the security algorithm selection system of the invention;

FIG. 8 is a block diagram of an algorithm regrouping unit of the security algorithm selection system of the invention;

FIG. 9 is a block diagram of a third embodiment of the security algorithm selection system of the invention;

FIG. 10 is a block diagram of a fourth embodiment of the security algorithm selection system of the invention;

FIG. 11 is a step flow chart of a first embodiment of a security algorithm selection method of the invention; and

FIG. 12 is a step flow chart of a second embodiment of the security algorithm selection method of the invention.

### DETAILED DESCRIPTION OF THE INVENTION

The above objects of the invention, as well as its structural and functional features, will be described in accordance with the preferred embodiments of the accompanying drawings.

In the following, for the formation and technical content related to a security algorithm selection system and a selection method thereof of the invention, various applicable examples are exemplified and explained in detail with reference to the accompanying drawings; however, the invention is of course not limited to the enumerated embodiments, drawings, or detailed descriptions.

Furthermore, those who are familiar with this technology should also understand that the enumerated embodiments and accompanying drawings are only for reference and explanation, and are not used to limit the invention; other modifications or alterations that can be easily implemented based on the detailed descriptions of the invention are also deemed to be within the scope without departing from the spirit or intention thereof as defined by the appended claims and their legal equivalents.

And, the directional terms mentioned in the following embodiments, for example: “above”, “below”, “left”, “right”, “front”, “rear”, etc., are only directions referring in the accompanying drawings. Therefore, the directional terms are used to illustrate rather than limit the invention. In addition, in the following embodiments, the same or similar elements will be labeled with the same or similar numbers.

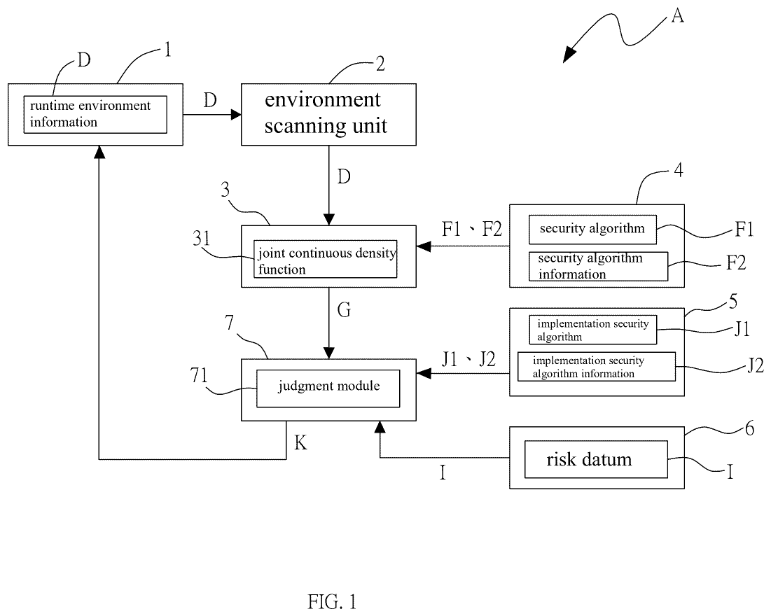

Please refer to FIG. 1 for a block diagram of a first embodiment of a security algorithm selection system of the invention. As shown in the figure, a security algorithm selection system A comprises an electronic device 1, an environment scanning unit 2, an algorithm evaluation unit 3, a security algorithm database 4, a security algorithm instance database 5, an instance risk database 6, and a risk evaluation unit 7.

The electronic device 1 comprises at least one runtime environment information D, wherein the electronic device 1 can be one of central processing unit, on-board computer, personal computer, server, field programmable gate array, complex programmable logic device, microcontroller unit, wearable electronic device, portable electronic device, uncrewed vehicle, another equivalent device, or a combination thereof, the runtime environment information D is hardware parameters and software parameters of the electronic device 1, wherein the hardware parameters can be central processing unit, graphics processing unit, hard disk drive, solid-state drive, random access memory or power supply unit, usage rates, idle resources, models or specifications of the above-mentioned hardware, and the software parameters can be information of runtime environment, permission or memory segmentation.

The environment scanning unit 2 is used to scan the electronic device 1 and obtain the runtime environment information D. The environment scanning unit 2 can be a software and hardware effectiveness monitor or an execution program.

The security algorithm database 4 comprises a security algorithm F1 and a security algorithm information F2. The security algorithm database 4 mainly contains security algorithms or standard specifications of security algorithms recognized and announced by world or national standard units. The world or national standard units are, for example, the National Institute of Standards and Technology, the European Union Agency for Cybersecurity, or units that comply with the relevant cybersecurity framework issued. In addition, the security algorithm F1 can be one of post-quantum cryptography, lattice-based cryptography, learning with errors, multivariate cryptography, hash-based cryptography, code-based cryptography, supersingular elliptic curve isogeny cryptography, symmetric-key algorithm, public-key cryptography. The security algorithm information F2 is relevant information of the security algorithm F1, such as: applicable hardware, energy consumption, implementation environment.

The algorithm evaluation unit 3 is equipped with at least one joint continuous density function 31. The algorithm evaluation unit 3 receives the runtime environment information D from the environment scanning unit 2 and receives the security algorithm F1 from the security algorithm database 4, and then uses the joint continuous density function 31 to operate the runtime environment information D and the security algorithm F1 to generate a first security algorithm information G. Further, the algorithm evaluation unit 3 can also receive the security algorithm information F2 at the same time, and operate to generate the first security algorithm information G. Wherein the joint continuous density function 31 can be artificial intelligence model, screen or analyzer, the first security algorithm information G can be post-quantum cryptography, encryption algorithm or another equivalent security algorithm, the first security algorithm information G can further comprise security algorithm information, such as: one of effectiveness consumption, effectiveness requirements, exception detection, exception handling, execution steps, or a combination thereof. In other words, the algorithm evaluation unit 3 first screens security algorithms according to an effectiveness of the electronic device 1.

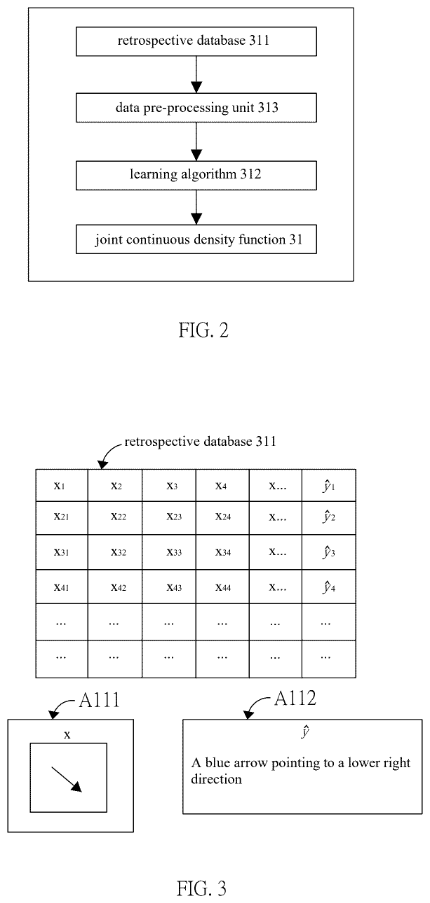

Please refer to FIGS. 2 to 6. The joint continuous density function 31 can be either a probability model or an analytic function or a combination thereof corresponding to a latent space, the probability model corresponding to the latent space can comprise one of generative adversarial network, Gaussian mixture model, maximum likelihood estimation, hidden Markov model, Naive Bayes classifier, logistic regression, linear regression, support vector machine, decision tree, extreme gradient boosting, generative pre-trained transformer, or a combination thereof.

In addition, please refer to FIG. 2. The joint continuous density function 31 is generated by using a retrospective database 311 with at least one learning algorithm 312; the retrospective database 311 comprises either at least one set of multi-dimensional information or an expected output of the learning algorithm 312, or a combination thereof.

After the joint continuous density function 31 is generated by the learning algorithms 312, the other retrospective database 311 or a data set with a same composition as the retrospective database 311 is used to modulate the probability model and/or the analytic function corresponding to the joint continuous density function 31 in a fine-tuning manner to enable the joint continuous density function 31 to have an efficacy of fitting data distribution of the other retrospective database 31.

In addition, please refer to FIG. 3, one set of data of the retrospective database 311 is mathematically expressed, which can be (x₁, x₂, x₃, . . . )→ŷ, wherein (x₁, x₂, x₃, . . . ) is a set of input data, ŷ is an expected output; in description of the retrospective database 311 in a practical application scenario, if the application scenario is picture recognition, (x₁, x₂, x₃, . . . ) is an input picture, ŷ is a content of the picture, for example, in FIG. 3, A111 is a picture, representing (x₁, x₂, x₃, . . . ); A112 is a description of the picture, representing ŷ; if the application scenario is weather prediction system, (x₁, x₂, x₃, . . . ) is past weather data, ŷ is weather data of the next day; if the application scenario is auxiliary decision-making system, (x₁, x₂, x₃, . . . ) is a set of environmental data and user requirements, ŷ is decision-making suggestions; or the application scenario is a combination of any equivalent relationships.

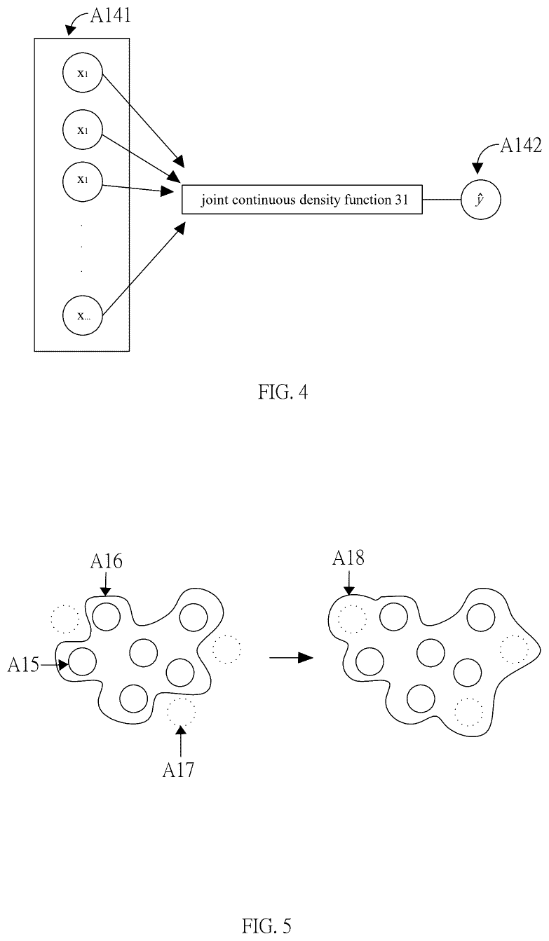

Please refer to FIG. 4 for a schematic diagram of input and output of the joint continuous density function 31, wherein A141 is an input data, which has the same representative meaning as A111 in FIG. 3; A142 is an output data of the joint continuous density function 31, which has the same representative meaning as A112 in FIG. 3, wherein an input quantity of A111 is variable; in addition, A141 input and A142 output do not need to exist in the retrospective database 311 first, and can be brand new data.

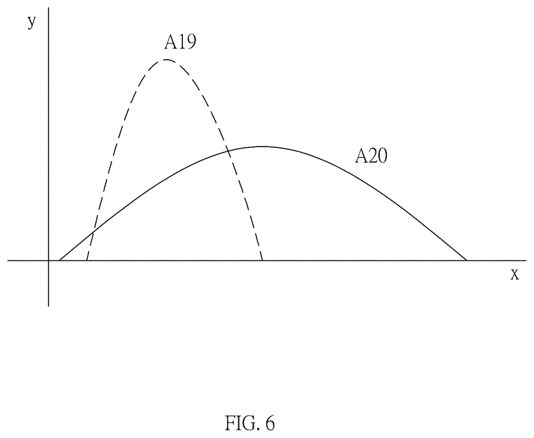

Please refer to FIG. 5 for a method of modulating the joint continuous density function 31 using the other retrospective database 311. In the figure, A15 is data distribution of the original retrospective database 311 that is input with the at least one learning algorithm 312; A16 is a coverage range of the original joint continuous density function 31, A17 is data distribution of the other retrospective database 311, A18 is the modulated joint continuous density function 31. Implementation is carried out by changing a coverage range of a probability distribution model to cover newly added data, its efficacy is to provide a method of using the other retrospective database 311 to modulate the joint continuous density function 31 to speed up generation of the joint continuous density function 31.

Please refer to FIG. 6, which uses a probability distribution function (PDF) to provide a simple example using a single parameter to illustrate FIG. 3; wherein the horizontal axis x is a value of the parameter, the vertical axis y is a probability of an event, A19 is a PDF before modulation, A20 is a PDF after modulation.

The retrospective database 311 described in the specification uses at least one data pre-processing unit 313 to ensure an accuracy and/or a completeness of its data. The data pre-processing units 313 perform one of data cleansing, data standardization and normalization, max-min algorithms, standard score (z-score), absolute maximum value standardization (MaxAbs), robust scaler, means, standard deviation, algorithms capable of placing data in a floating point number between 0 and 1, and confidence learning, or a combination thereof, and each batch of data in the retrospective database 311 can be used as input data for the learning algorithm 312.

The learning algorithm 312 described in the specification at least comprises backpropagation algorithm, supervised learning, semi-supervised learning, ensemble learning, active learning, reinforcement learning, generative model, discriminative model, long short-term memory, object detection, instance segmentation and diffusion model.

The security algorithm instance database 5 comprises at least one implementation security algorithm J1 and one implementation security algorithm information J2. It is further explained that the implementation security algorithm J1 is the security algorithm F1 modulated in response to various runtime environments, and the implementation security algorithm information J2 can be one or a combination of a dependent library of the implementation security algorithm J1, effectiveness requirements for executing the implementation security algorithm J1, hardware or software requirements for executing the implementation security algorithm J1. Since the security algorithm F1 has its applicable runtime environment, if a runtime environment is different, the security algorithm F1 needs to be adjusted to facilitate operation in different environments. The runtime environment at least comprises one of equivalent environments of Java runtime environment, C#, Visual Basic.NET, C++.NET, common language runtime, or a combination thereof.

The instance risk database 6 comprises at least one corresponding risk datum I. The corresponding risk data I are corresponding risk data of various instances of the security algorithm F1 and the implemented security algorithm J1. The risk datum I is, for example: one or a combination of vulnerability in information security, structural hazard, data hazard, control hazard, algorithm defects, risk avoidance methods, the risks mentioned are difficult to solve or too costly to solve in current environments, so they have not yet been overcome. However, most of the risks have corresponding risk avoidance methods.

The risk evaluation unit 7 is equipped with at least one judgment module 71. The risk evaluation unit 7 obtains the first security algorithm information G from the algorithm evaluation unit 3, obtains the implementation security algorithm J1 from the security algorithm instance database 5, and obtains the corresponding risk datum I from the instance risk database 6, and then at least one second security algorithm information K is generated through operation of the judgment module 71. Further, the risk evaluation unit 7 can also receive the implementation security algorithm information J2 at the same time, and operate to generate the second security algorithm information K, and then transmit the second security algorithm information K to the electronic device 1. The judgment module 71 can be one or a combination of joint continuous density function, analytical function, deterministic algorithm, nondeterministic algorithm, artificial intelligence model. In other words, the risk evaluation unit 7 screens security algorithms based on risk information of the security algorithms, and selects implementable security algorithms to be transmitted to the electronic device 1 for use.

The second security algorithm information K can be post-quantum cryptography, encryption algorithm or other equivalent security algorithms. The first security algorithm information G can further comprise security algorithm information, such as: one or a combination of effectiveness consumption, effectiveness requirements, exception detection, execution steps, exception handling.

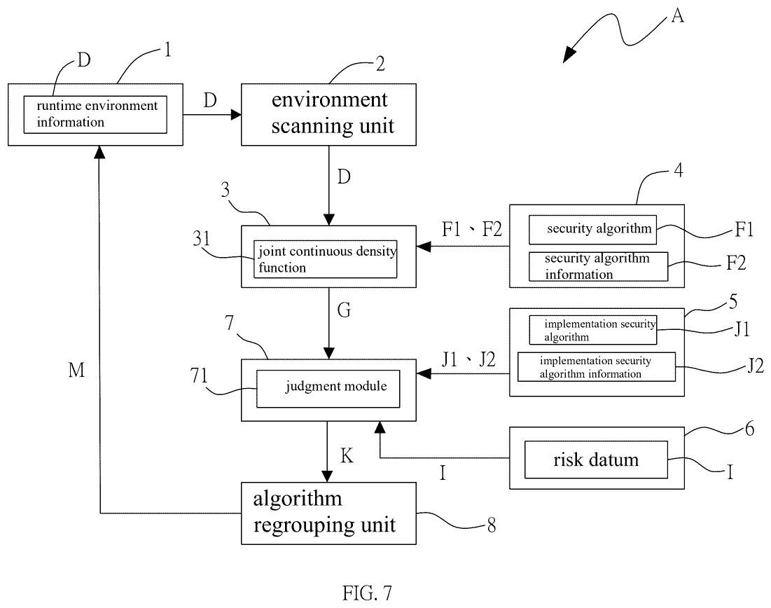

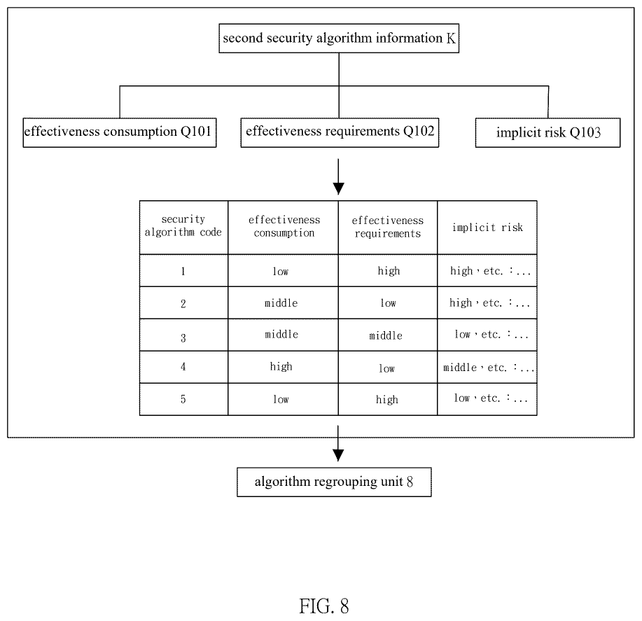

Please refer to FIGS. 7 and 8 for block diagrams of a second embodiment of the security algorithm selection system of the invention. The security algorithm selection system further has an algorithm regrouping unit 8. The algorithm regrouping unit 8 obtains the second security algorithm information K from the risk evaluation unit 7, then screens the second security algorithm information K, and then regroups the screened second security algorithm information K to generate at least one instruction set M, and transmits the instruction set M to the electronic device 1. Wherein the instruction set M can be one or a combination of machine language, native code, programming language, library, reduced instruction set computer, complex instruction set computer, one instruction set computer, security encryption algorithms, further illustrating that the algorithm regrouping unit 8 is capable of automatically screening the second security algorithm information K according to a program, and then reorganizing the screened second security algorithm information K to generate the at least one instruction set M. In further explanation, a method of automatic screening by a program is that a user first inputs at least one requirement information Q regarding the second security algorithm information K. The requirement information Q can be a quantified or generalized expression method of one or a combination of effectiveness consumption Q101, effectiveness requirements Q102, and implicit risk Q103, such as 0% to 100%, or low, medium, high. Then the algorithm regrouping unit 8 selects the at least one second security algorithm information K based on the requirement information Q and the second security algorithm information K, and then reorganizes the at least one second security algorithm information K into the instruction set M, or the user uses a user interface to randomly select a set of the second security algorithm information K from the second security algorithm information K, and then the algorithm regrouping unit 8 regroups the second security algorithm information K into the instruction set M.

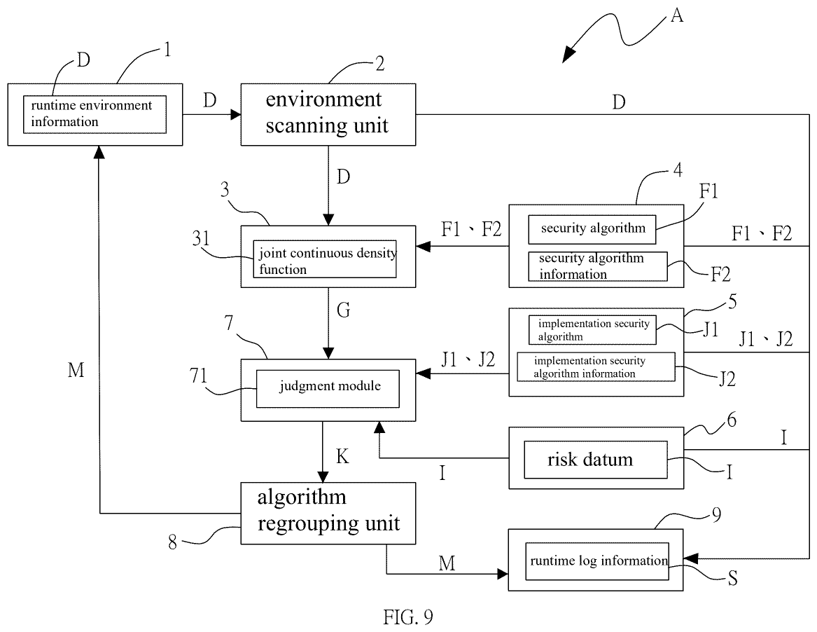

Please refer to FIG. 9. The security algorithm selection system comprises a storage unit 9, the storage unit 9 stores at least one runtime log information S. The runtime log information S comprises one or a combination of the runtime environment information D, the security algorithm F1, the security algorithm information F2, the first security algorithm information G, the implementation security algorithm J1, the implementation security algorithm information J2, the corresponding risk datum I, the second security algorithm information K, the instruction set M.

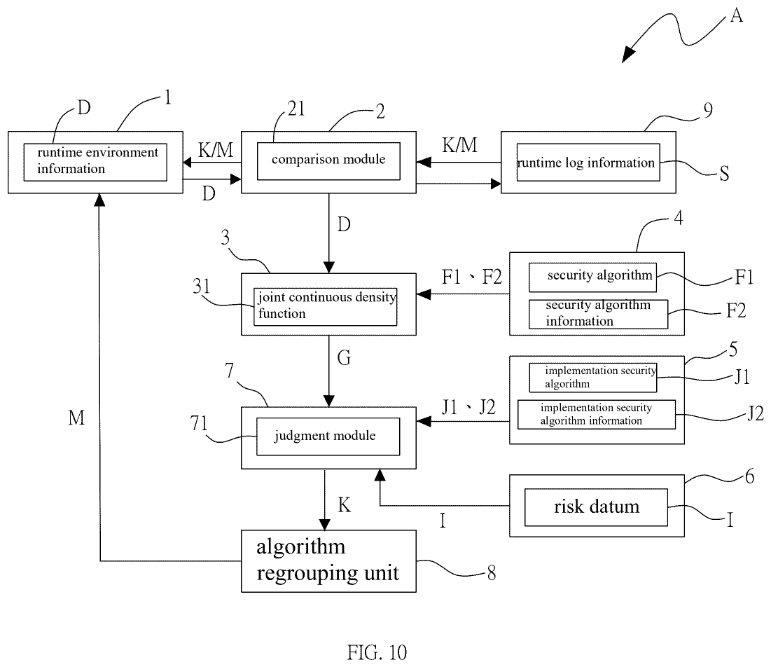

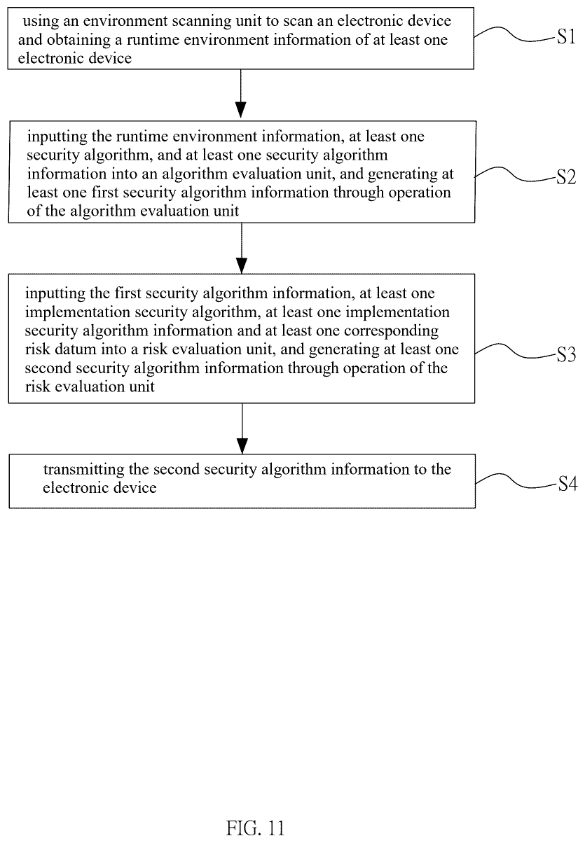

Please refer to FIG. 10. The environment scanning unit 2 further comprises a comparison module 21. When the environment scanning unit 2 obtains the runtime environment information D, the comparison module 21 compares the runtime log information S with the runtime environment information D, if the runtime log information S has historical runtime environment information corresponding to the runtime environment information D, then the corresponding second security algorithm information K or the instruction set M is directly obtained from the runtime log information S, and then the corresponding second security algorithm information K or the instruction set M is sent to electronic device 1.

Please refer to FIG. 11 for a step flow chart of a first embodiment of a security algorithm selection method provided by the invention. The security algorithm selection method comprises following steps:
S1: using an environment scanning unit to scan an electronic device and obtaining a runtime environment information of at least one electronic device;
S2: inputting the runtime environment information, at least one security algorithm, and at least one security algorithm information into an algorithm evaluation unit, and generating at least one first security algorithm information through operation of the algorithm evaluation unit;
S3: inputting the first security algorithm information, at least one implementation security algorithm, at least one implementation security algorithm information and at least one corresponding risk datum into a risk evaluation unit, and generating at least one second security algorithm information through operation of the risk evaluation unit; and
S4: transmitting the second security algorithm information to the electronic device.

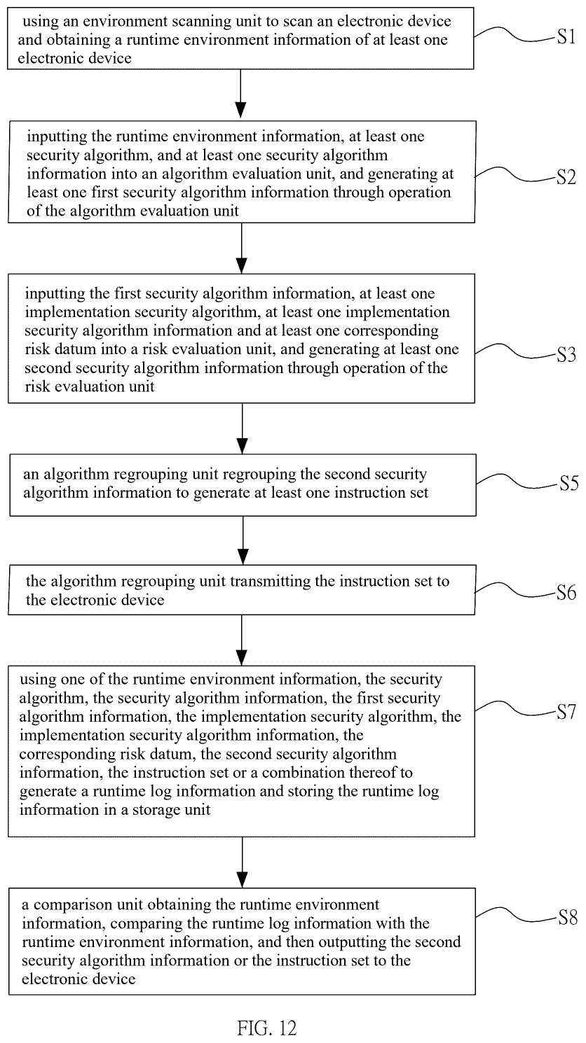

Finally, please refer to FIG. 12 for a step flow chart of a second embodiment of the security algorithm selection method provided by the invention, wherein after step S3 of generating at least one second security algorithm information through operation of the risk evaluation unit, further comprises:
S5: an algorithm regrouping unit regrouping the second security algorithm information to generate at least one instruction set;
S6: the algorithm regrouping unit transmitting the instruction set to the electronic device;
S7: using one of the runtime environment information, the security algorithm, the security algorithm information, the first security algorithm information, the implementation security algorithm, the implementation security algorithm information, the corresponding risk datum, the second security algorithm information, the instruction set or a combination thereof to generate a runtime log information and storing the runtime log information in a storage unit; and
S8: a comparison unit obtaining the runtime environment information, comparing the runtime log information with the runtime environment information, and then outputting the second security algorithm information or the instruction set to the electronic device.

It is to be understood that the above description is provided for the preferred embodiments of the invention and is not used to limit the invention, and changes in accordance with the concepts of the invention may be made without departing from the spirit of the invention, for example, the equivalent effects produced by various transformations, variations, modifications and applications made to the configurations or arrangements shall still fall within the scope covered by the appended claims of the invention.

What is claimed is:

1. A security algorithm selection system comprising:
an electronic device comprising at least one runtime environment information;
an environment scanning unit used for scanning the electronic device and obtaining the runtime environment information;
a security algorithm database comprising a security algorithm and a security algorithm information;
an algorithm evaluation unit equipped with at least one joint continuous density function, the algorithm evaluation unit receiving the runtime environment information from the environment scanning unit, receiving the security algorithm from the security algorithm database, and then using the joint continuous density function to operate the runtime environment information and the security algorithm to generate a first security algorithm information;
a security algorithm instance database comprising at least one implementation security algorithm and an implementation security algorithm information;
an instance risk database comprising at least one corresponding risk datum, the corresponding risk data being corresponding risk data of various instances of the security algorithm and the implementation security algorithm; and
a risk evaluation unit having at least one judgment module, the risk evaluation unit obtaining the first security algorithm information from the algorithm evaluation unit, obtaining the at least one corresponding risk datum from the instance risk database, generating at least one second security algorithm information through calculation by the judgment module, and then transmitting the second security algorithm information to the electronic device.

2. The security algorithm selection system as claimed in claim 1, wherein further comprising an algorithm regrouping unit for obtaining the second security algorithm information from the risk evaluation unit, screening the second security algorithm information, and then regrouping the screened second security algorithm information to generate at least one instruction set, and transmitting the instruction set to the electronic device.

3. The security algorithm selection system as claimed in claim 1, wherein the joint continuous density function can be either a probability model or an analytic function or a combination thereof corresponding to a latent space.

4. The security algorithm selection system as claimed in claim 1, wherein the first security algorithm information and the second security algorithm information comprise one of an equation, execution steps, effectiveness consumption, effectiveness requirements, implicit risks, exception detection, exception handling, or a combination thereof, which can be transformed into at least one instruction set based on information contained therein.

5. The security algorithm selection system as claimed in claim 1, wherein the joint continuous density function is generated by using a retrospective database with at least one learning algorithm, the retrospective database comprises either at least one set of multi-dimensional information or an expected output of the learning algorithm, or a combination thereof.

6. The security algorithm selection system as claimed in claim 5, wherein one of the security algorithm database, the retrospective database, the instance risk database, the security algorithm instance database, or a combination thereof is updated automatically or manually based on a joint continuous density function trained by a learning algorithm.

7. The security algorithm selection system as claimed in claim 1, wherein further comprising a storage unit, the storage unit stores at least one runtime log information, the runtime log information comprises one or a combination of the runtime environment information, the security algorithm, the security algorithm information, the first security algorithm information, the implementation security algorithm, the implementation security algorithm information, the corresponding risk datum, the second security algorithm information, the instruction set.

8. The security algorithm selection system as claimed in claim 1, wherein the environment scanning unit further comprises a comparison module, when the environment scanning unit obtains the runtime environment information, the comparison module compares the runtime log information with the runtime environment information, if the runtime log information has historical runtime environment information corresponding to the runtime environment information, then the corresponding second security algorithm information or the instruction set is directly obtained from the runtime log information, and then the corresponding second security algorithm information or the instruction set is sent to electronic device.

9. A security algorithm selection method comprising following steps:
S1: using an environment scanning unit to scan an electronic device and obtaining a runtime environment information of at least one electronic device;
S2: inputting the runtime environment information, at least one security algorithm, and at least one security algorithm information into an algorithm evaluation unit, and generating at least one first security algorithm information through operation of the algorithm evaluation unit;
S3: inputting the first security algorithm information, at least one implementation security algorithm, at least one implementation security algorithm information and at least one corresponding risk datum into a risk evaluation unit, and generating at least one second security algorithm information through operation of the risk evaluation unit; and
S4: transmitting the second security algorithm information to the electronic device.

10. The security algorithm selection method as claimed in claim 9, wherein after step S3 of generating at least one second security algorithm information through operation of the risk evaluation unit, further comprising:
S5: an algorithm regrouping unit regrouping the second security algorithm information to generate at least one instruction set;
S6: the algorithm regrouping unit transmitting the instruction set to the electronic device;
S7: using one of the runtime environment information, the security algorithm, the security algorithm information, the first security algorithm information, the implementation security algorithm, the implementation security algorithm information, the corresponding risk datum, the second security algorithm information, the instruction set or a combination thereof to generate a runtime log information and storing the runtime log information in a storage unit; and
S8: a comparison unit obtaining the runtime environment information, comparing the runtime log information with the runtime environment information, and then outputting the second security algorithm information or the instruction set to the electronic device.
